(19) United States
(12) Patent Application Publication
(10) Pub. No.: US 2023/0104805 A1
(43) Pub. Date: Apr. 6, 2023

(54) COMMUNICATIONS DEVICES, SERVICE PROVIDER APPARATUS, AND METHODS

(71) Applicants: Sony Europe B.V., Surrey (GB); Sony Group Corporation, Tokyo (JP)

(72) Inventor: Renaud DiFrancesco, London (GB)

(21) Appl. No.: 17/798,872

(22) PCT Filed: Mar. 2, 2021
(86) PCT No.: PCT/EP2021/055143

§ 371 Date: Aug. 10, 2022

(30) Foreign Application Priority Data
Mar. 31, 2020 (EP) 20167397.7

(51) Int. Cl. G06Q 40/02; G06F 21/62

(52) U.S. Cl. CPC G06Q 40/025; G06F 21/6245

(57) ABSTRACT

A communications device suitable for requesting a service for requesting a service from a service provider is provided. The communications device comprises a processor and a memory. The memory comprises instructions which when executed, cause the processor to transmit a request for the service, wherein the request comprises an indication that the service provider is authorised to access a data container, the data container comprising an indication of at least a portion of an identity of a user of the communications device and an indication of at least a portion of a credit of the user, and to receive a response from the service provider, the response indicating whether or not the user of the communications device is authorised to obtain the service based on the indication of the identity of the user and the indication of the credit of the user. One or both of the at least the portion of the identity of the user and the at least the portion of the credit of the user are characterisable by the user when generating the request for the service.

### BACKGROUND

### Field of Disclosure

The present disclosure relates generally to request of a service by a communications device from a service provider, where the request provides the service provider with authorisation to access characterisable indications of the identity and credit of a user of the communications device.

The present applications claims the Paris Convention priority from European patent application number EP20167397.7, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Every human has an identity, which may be linked to their physical biological person, from birth until death. This physical identity may be adapted over time, due to changes in their legal status (for example, through marriage, divorce, or similar partnership contracts), or due to deeper alterations, such as a gender or sex change. Despite such potential adaptations, a human's physical identity will remain essentially stable over the course of their lifetime.

Similarly, each human also has credit, which based on the Latin meaning of the word may be said to define that person's commitment and ability to keep something; such a financial payment, to a deadline, proof of powers to represent an organisation, etc. Unlike a human's identity, their credit does change dynamically over time, with the building of a credit record based on a history of that person's actions and transactions.

Often, when a person is seeking to obtain (or indeed, provide) a service from an organisation or company, there is an asymmetry between the requirements for the provision of the person's identity and credit and those of the organisation. This may result in the person being provided or offered with a service that does not fulfil their requirements, or is not provided on fair and reasonable terms. Furthermore, irrelevant personal information may be provided to the service provider that is not needed for the obtaining of the service itself, which may result in the person's data and information being used in some other manner against their wishes or without them being aware. Yet further, without awareness of the company or service provider's reputation, history or quality of service, the person seeking to obtain the service is not provided with all relevant information needed to determine whether or not that service is what they seek. Further still, without accurate knowledge of their own credit information, a person cannot be sure they will be able to access a particular service, and attempting to do so may result in unnecessary sharing of their own personal information.

### SUMMARY OF THE DISCLOSURE

The present disclosure can help address or mitigate at least some of the issues discussed above.

Embodiments of the present technique can provide a communications device suitable for requesting a service for requesting a service from a service provider. The communications device comprises a processor and a memory. The memory comprises instructions which when executed, cause the processor to transmit a request for the service, wherein the request comprises an indication that the service provider is authorised to access a data container, the data container comprising an indication of at least a portion of an identity of a user of the communications device and an indication of at least a portion of a credit of the user, and to receive a response from the service provider, the response indicating whether or not the user of the communications device is authorised to obtain the service based on the indication of the identity of the user and the indication of the credit of the user. One or both of the at least the portion of the identity of the user and the at least the portion of the credit of the user are characterisable by the user when generating the request for the service.

Embodiments of the present technique, which further relate to service provider apparatus, methods of operating communications devices and service provider apparatus, and circuitry for communications devices and service provider apparatus, allow for services to be requested by communications devices and provided by service providers in a secure and simple manner, whilst ensuring that maximum confidentiality, privacy and transparency is enabled for all parties involved in such an interaction.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 illustrates an example of a service request by a communications device and provision of the service by a service provider in accordance with at least some embodiments of the present technique;

FIG. 2 illustrates an example of a communications device in accordance with at least some embodiments of the present technique; and

FIG. 3 illustrates an example message flow diagram between a communications device and a service provider in accordance with at least some embodiments of the present technique.

### DETAILED DESCRIPTION OF THE EMBODIMENTS

Identity and Credit

Both identity and credit are long established and well-understood concepts. An identity—of a person or of an organisation—is stable over time, and it defines and identifies (whether biologically, legally or physically) that person or organisation, regardless of conditions or scenarios under which the definition of that identity is required to be known. This identity is typically verified by an identification, particularly when a transaction or interaction is taking place between two persons/organisations who require confirmation of one another's identity when they do not share a high enough mutual trust.

Credit, on the other hand, is subject to change along with the conditions or scenarios under which such credit is required to be known. Credit also changes over time, as a history of transactions, interactions, and past commitments is built up, with particular relevance and importance being placed on the credit holder's record of sticking to the terms and expectations of such transactions, interactions, and commitments, as well as providing valid, correct, and verifiable identifications of their identity whilst doing so.

Identity and credit are concepts and tools that have been used for transactions and interactions for a long time. Traditionally, verification of identity and credit would have been primarily physical; identity through physical recognition, familiarity, and physical documentation, and credit similarly through personal past dealings, reputation, and physical credit history documentation or other documentation such credit notes or IOUs. Again, verification of both identity and credit could be based on acquired mutual trust. However, with the advent of computers in the modern digital age, tradition methods of identity and credit verification are not always suitable.

Given the importance of both a person's or organisation's identity and credit, security is vital in the exchange of identity and credit between parties during transactions and interactions. This is particularly true for digital interactions, where credit and identify fraud are easier for criminals to perpetrate, using sophisticated and silent methods that may result in the fraud not being apparent until long after it has happened, than physical impersonation or theft/forgery of physical documents.

As stated above, identity and credit may not apply only to a legal or biological person, but to a legal organisation as well, such as service providers or governmental institutions for example. Thus, interactions which require sharing or exchanging of identity and credit may take place between the following parties, which are referred to throughout the present disclosure:
Person P(i) and person P(j);
Person P(i) (or P(j)) and organisation P′(k) (or P′(l)); or
Organisation P′(k) and organisation P′(l).

Such interactions may comprise several different phases, depending on whether these are online (i.e. digital) or offline (i.e. physical). For online interactions in some examples, the phases may include, in order, an establishment phase during which the terms and type of the interaction is established, including the setting up of a communications stream between two (or more) parties involved in the interaction, an establishment of what service(s) or information is being provided and in exchange for what, an execution phase during which the established interaction is effectuated, and a termination phase during which the interaction is ended, and a communications stream between the two or more interacting parties is stopped.

For offline interactions, in some examples the phases may include, a notarisation phase during which the request is recorded and the terms for the interaction are agreed upon by the two or more parties involved, a phase of storage/retrieval of notarised records in which the required service or information is accessed, and a planning phase during which the actual exchange of information that characterises the interaction is made. Again, like online interactions, offline interactions may also or alternatively include establishment, execution and termination phases.

Such interactions may comprise a large number of things. For example, this may be a communication session, which may be online (for example a telephone type voice communication or a video chat) or may be a non-interactive, offline, physical conversation. The interaction may be a contract signing, where all parties involved provide their identities and their commitment to stick to the terms of the contract in a legal setting, where there has been an assessed feasibility of the commitment required versus the previous credit history (including a record of ability to stick to similar commitments) from one or both sides. Another type of interaction is a purchase, which comprises identified parties, goods or services to purchase, conditions on sale, and again, the required commitments. Here, such commitments may include that payment will be made within an agreed timeframe by a first party, and that the reception of payment by a second party will result in both the provision of a good/service adhering to that which was advertised prior to the interaction, and the supporting of conditions of sales over time (e.g. returns, guarantees, after-sales services, etc.). A further type of interaction is a service provision, which similarly to a purchase, comprises the identified parties, service features and details, and commitments, both to pay within the agreed timeframe on one side, and to deliver the benefits and/or results agreed on the other.

All parties involved will likely be required or will desire to verify the other party's/parties' identity, and similarly to prove their own identity in reciprocity. Likewise, all parties will need or want to be aware of the profiles or credit of the other interacting party/parties. This includes, based on past history of the other party, a record of their demonstrated capabilities and behavioural features, whether or not the party can trust the relevance of interacting with the other party, and enables the party to assess that mutual objectives are actually common and attainable. The same is true of the other parties involved in the interaction. This ensures that all parties are certain of the terms and the relevance of the interaction. This may also involve the parties determining and mutually agreeing on interaction objectives, and each having an expectation that a joint approach enabled by the transaction/interaction will bring something more than an individual approach as if the interaction did not happen; to every party involved.

Essentially, for each party involved in an interaction or transaction, the necessity for accurate and verifiable identity and credit information of other involved parties boils down to questions of whether the party can trust the other party/parties to be who the say they are, and do what the say they'll do. In other words, an exchange of credit and identity information is required for a transaction, where a first party determines whether another party is who they claim to be and whether they can trust the other party to keep their commitments, whilst the first party themselves prove who they are and prove their ability to keep commitments.

Embodiments of the present technique provide solutions to achieve this in a secure and simple manner, whilst ensuring that maximum confidentiality, privacy and transparency is enabled for all parties involved in an interaction.

Digital Interaction Profile

Embodiments of the present technique may provide a Digital Interaction Profile (DIP) of one or both of a user and a service provider. The DIP indicates both a permanent identity, and a credit or credit history at a particular point in time. The DIP (of either the user or the service provider) can be transmitted between a user's communications device and a service provider either directly, or can be stored remotely and authorisation granted by one of the user or the service provider to the other to access the DIP of the one of the user or the service provider.

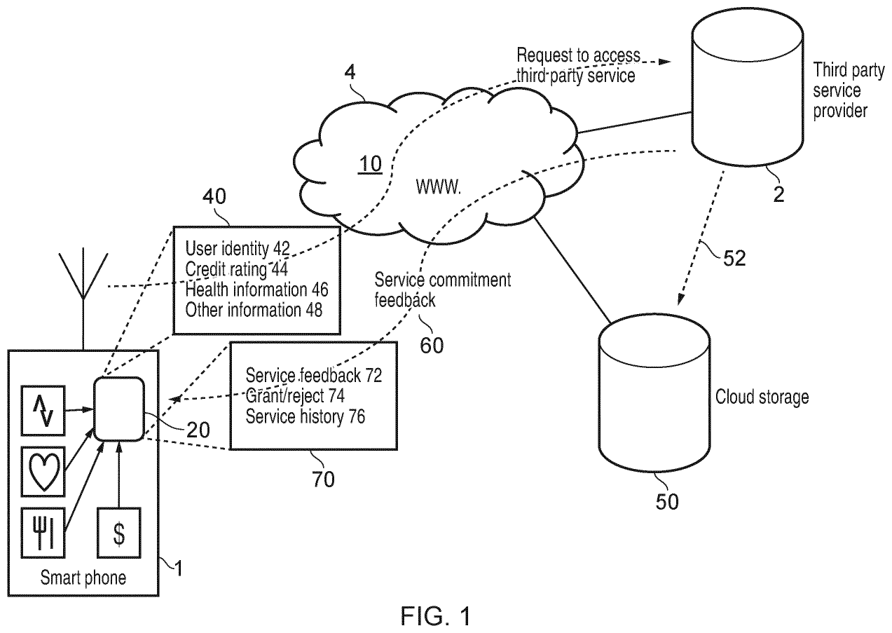

An example embodiment of the present technique is illustrated by FIG. 1, in which a user procures a service from a third party service provider using a system configured in accordance with an example embodiment. As shown by FIG. 1, the communications device 1, which may be a smart phone or the like, is operated by a user who may wish to procure a service from the service provider 2. In the example shown by FIG. 1 the service provider 2 operates or has access to a server to providing an online service via a communications network 4, such as the World Wide Web. As represented by arrow 10, the user of the smart phone 1 accesses a service offered by the third party provider 2 via a web page or app or similar.

According to the example shown by FIG. 1, the user of the smart phone 1 accesses a service by communicating with a third party server as represented by the arrow 10. This may be done, for example, by using an application program (e.g. a smart phone app) 20. As shown within the expanded box 40, the smart phone app 20 provides a secure and encrypted data container 40—which provides the digital interaction profile of the user—or otherwise provides authorised access to a secure and encrypted data container 40, which is configured to include and to update user information identifying the user as well as providing other information which may be pertinent to procuring the service from the third party service provider. The secure data container 40 may therefore include an identity of the user 42, which provides a field which uniquely identifies the user of the application who is attempting to secure the service, information concerning the credit rating, history or other credit sensitive information 44, information such as the user's health 46 or other information 48 which is provided to securing the service from the third party provider 2. More generally, the information fields 44, 46, 48 in the secure data container 40 comprise information which varies or accumulates over time and pertains to an individual (for example, the user of the communications device 1). Those skilled in the art would appreciate that any relevant information could be comprised within these fields 44, 46, 48 and is not just limited to financial or other credit information or health information.

According to some embodiments of the present technique, as part of the access by the user 1 to the third party server 2 represented by the arrow 10, the secure data container 40 may be embodied in memory on the communications device 1 and communicated to the third party provider 2, or otherwise authentication information allowing the third party provider 2 to access the information may be provided. For example, the secure data container 40 may be stored in a cloud storage server 50 and accessed (represented by the dotted arrow 52) directly from the third party provider 2 using the information provided by the smart phone app 20. Where the data container 40 is embodied in memory on the communications device 1, this may be a specific portion of memory which is more securely protected than other portions of memory. When the data container 40 is stored in in the memory on the communications device 1 or in a cloud storage server 50, the data container 40 may be a file, data structure, database, or a presentation of a database residing on a non-transitory storage medium.

The information provided by the secure data container 40 is firstly arranged to identify the user 42 but also provides information such as the user's credit rating 44, as well as other relevant information 46, 48 to the service being received and procured by the user. For example, the credit rating may be used to secure credit by the user where as the health information 46 may be used to assess a premium for procuring insurance from the third party provider 2. Of course, those skilled in the art would appreciate that the service desired by the user may relate to one of a large number of things and is not limited to insurance or other financial services, and at least some other examples will be explained below. In response, the third party service provider 2 may also send via the network in response some feedback information including a service commitment, as represented by arrow 60. As shown the service commitment may be received by the smart phone app 20 indicated within the window 70 which may provide a second secure data container 70. The secure data container 70 may provide service feedback information 72, and information defining either that the request for the service has been granted or rejected 74, and indicating for example why the service request has been rejected. The secure data container 70 may also comprise information relating to a service history 76 of the third party service provider 2 itself, providing the user with transparency on, for example, the reputation, commitment history, and quality of service provided by the third party service provider 2.

According to the present technique therefore, a secure data container providing user information which is generated and controlled by the user is exchanged with a service provider which also provides information associated with its credibility to provide that service and also providing conditions for offering that service to the user and bases on the user's information.

As explained above, there are various embodiments in which the container may be either stored on the smart phone in encrypted form using the smart phone app 20, or it may be stored in the cloud represented by a storage server 50 and is accessed by the service provider 2 as represented by the arrow 52. In this latter example, the smart phone app 20 transmits a token or some other form of authorisation information to the service provider represented, using the communications stream represented by the arrow 10, which can be used by the service provider to access the secure data container in the cloud storage device 50. In other words, in some arrangements of embodiments of the present technique, the data container is stored in the memory of the communications device, whilst in some arrangements of embodiments of the present technique, the data container is stored remotely from the communications device, and the request for the service comprises authentication information for use by the service provider to access the data container from the remote storage.

In at least some arrangements of embodiments of the present technique, the user secure data container 40 includes unique information identifying and associated with the user 42. The secure data container will also contain credit information relating to the user 44, which may be independently verified, and may also include a list of recent purchases made by the user in order to validate, through personal activity, the credit viability of the user.

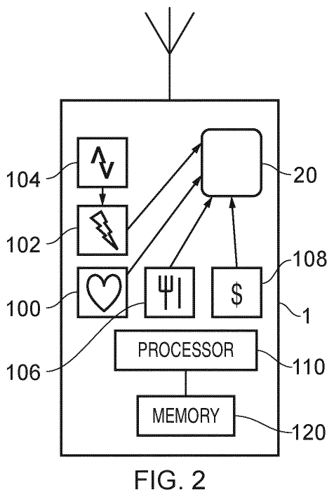

FIG. 2 shows an arrangement of the user communications device 1 in accordance with embodiments of the present technique, where the communications device 1 is arranged for requesting a service from a service provider 2. As well as smart phone app 20, the communications device comprises a processor 110 and a memory 120. The processor 110 may be, for example, a microprocessor(s), a CPU(s), a chip(s), or a dedicated chipset(s), etc. The memory comprises instructions which when executed, cause the processor 110 to transmit a request for the service (e.g. using the communications stream with the service provider as represented in FIG. 1 by arrow 10), wherein the request comprises an indication that the service provider 2 is authorised to access a data container 40, the data container comprising an indication of at least a portion of an identity 42 of a user of the communications device and an indication of at least a portion of a credit 44 of the user, and to receive a response 60 from the service provider, the response indicating whether or not the user of the communications device is authorised to obtain the service based on the indication of the identity 42 of the user and the indication of the credit 44 of the user. Here, one or both of the at least the portion of the identity 42 of the user and the at least the portion of the credit 44 of the user are characterisable by the user when generating the request for the service. That is, the user is able to—through operation of the communications device 40—define what portion(s) of their identity 42 and credit 44 information (as well as potentially health 46 or other 48 information) is shared with the third party service provider 2. Such characterisation of the user's identity 42 and credit information 44, 46, 48 provides simple choices and control regarding who (e.g. the service provider 2) gets access to the user's information, and to what degree that access should be granted.

In at least some arrangements of embodiments of the present technique, the one or both of the at least the portion of the identity 42 of the user and the at least the portion of the credit 44 of the user are characterisable by the user in that the user is able to effectuate customisable levels of visibility to the identity 42 and the credit 44 (as well as any other information 46, 48, in the secure data container 40). Each piece of information 42, 44, 46, 48 in the data container 40 may have a plurality of different visibility levels associated with it, and this may be so with any conceivable level of granularity (e.g. ranging from whether the identity or credit information is visible as a whole to the service provider 2, to whether each individual field in, for example, the identity information 42 or credit information 44 is visible to the service provider 2 or not). Here, the user may be able to partition the information 42, 44, 46, 48 with a selected level of granularity. Since credit data 44, 46, 48 may be hierarchical, the user may selectively control software to characterise only certain hierarchies. The segmentation and/or granularity may additionally or alternatively date driven, and the characterisation/partition may be done by date range. Furthermore, the segmentation/partition of hierarchies may be carried out by type of data, such as health, financial, reliability, etc. These can be further segmented; for example, financial information can be partitioned into repayment of financial credit, payment reliability, insurance (including claims), etc. Health information may be equally/similarly segmented, such as into parameters which can be easily self-measured by the user using the communications device 1 or other consumer devices, such as weight, heart rate, blood pressure, sleeping patterns, etc., and those which require more specialist (e.g. hospital) type equipment, such as certain blood tests. In accordance with embodiments of the present technique, appropriate hierarchies may be represented in Extensible Markup Language (XML) data for credit. Such health based information may be combinable with financial based information—indeed, all forms of credit as defined and described herein may be combinable in any conceivable way both in terms of the way in which it is indicated to the service provider 2 from the communications device 1 or to the communications device 1 from the service provider 2, and in the way in which it is analysed when a decision on whether or not to provide a service for example is taken. Here, for example, where health information is combinable with financial based information, such combined information may be pertinent to a private healthcare service provider in determining whether a user looking for aesthetic surgery at a private clinic should be offered such surgery.

Furthermore, in at least some arrangements of embodiments of the present technique, the one or both of the at least the portion of the identity 42 of the user and the at least the portion of the credit 44 of the user are characterisable by the user in that the user is able to control the at least the portion of the identity 42 of the user and the at least the portion of the credit 44 of the user (or any of the other information 46, 48) to each be a summarisation of the respective one or both of the identity 42 of the user and the credit of the user 44 (or other information 46, 48) comprising only information relevant to the requested service. Here, the user may, for example, categorise information 44,46, 48 and allow access by the service provider 2 to only to certain categories, or certain categories that are associated with certain services may be automatically included in the data container 40 and visible to the service provider 2 (though this may be overriden by the communications device 1). The user of the communications device 1 may also provide summarised information in accordance with such arrangements of embodiments of the present technique by permitting searching through credit information 44, 46, 48 (for example, by a search engine trained by a neural network—at or under control of the service provider 2—that is configured specifically for the service) to return only pertinent information, or to return some high level information and query the user about releasing more detailed information.

In some examples the secure data container may include health information providing an indication of the user's weight, height, heart rate, blood pressure, smoking history, use or prescription of medication, admission to hospital of the user or other health history. The health information may be generated by an app 100 which may be operating on the smart phone and may be providing information to the smart app 20 verifying the user's health information such as blood pressure and heart rate which may be continually monitored by the health app 100. Furthermore, an activity app 102 may monitor the user's activity through walking or other sports such as running, cycling or a work out and may also connect to other apps 104 to provide information to the smart app 20. For example, another app 104 that the activity app 102 may connect to may be a communal cycling app such as Strava or the like in which users record their cycling activities which are uploaded and stored on a server. By accessing the cycling activities from a communal cycling app 104, the smart app 20 can populate the secure data container 40 with activity information associated with the user. In embodiments, activity information may be summarised to show changes over time in activity levels, for example indicating a change in lifestyle, for example from sedentary to active, or at least a level of activeness. This information may be used to provide credibility of a lifestyle of the user thereby providing a third party service provider 2 with a known measure of credibility for the user for procuring a particular service such as life insurance, health insurance or other financial or non-financial services.

In another example dietary app 106 may be used by the user to record food which has been eaten or consumed or alcohol which has been drunk which may be used to populate the user's profile recorded in the secure data container 40. Such information may be used then to the credibility to a user's lifestyle in respect of their eating and/or drinking habits. This information again can be used by the third party service provider 2 to asses an individual in respect of their risk in providing the service and therefore may adjust such conditions for providing the service more favourably or less favourably dependence upon the user's diet and alcohol consumption. Conditions for providing the service may include proof or a declaration by the user of the communications device 1 that they are sticking to a health plan in terms of calories eaten, units drunk, cigarettes smoked etc., or may require daily weight or waist measurements reducing, staying constant, increasing, or sticking to some other trend. A similar example might be used monitor food shopping habits indicating the purchase of healthy or less healthy food and the quantity of food purchased. This could be used as an implicit measure of overconsumption of calorific intake, in embodiments averaged for an individual based on the number of people they are shopping for.

A further app 108 may relate to a financial history or credit history of the user (akin to a classical payment credit rating), and may provide information relating to a user's previous financial transactions including a history of the user's reliability of making payments and providing accurate information; i.e. whether the can keep up with repayment or whether they have or do experience issues. For example, the financial information of the user might comprise an indication of whether or not the user has a habit of running out of money, or has the ability to stick to monthly payments. Such information will again be useful for the service provider 2 to assess whether or not financial services may be provided to the user, such as whether the user would make a good tenant or whether the user would be a good candidate to offer a mortgage to.

The credit information 44 or health information 46 or other information 48 of the user of the communications device 1 may comprise information relating to their past behaviour, like arriving on-time for a service appointment (which is deemed to be a positive event as opposed to arriving late or being absent). In accordance with at least some embodiments of the present technique, positive credit history of a user of the communications device 1 may result in an increased future priority for such a user in obtaining related (or indeed unrelated) services, whilst conversely, poor credit history may result in some sort of penalty, like the user being required to go to the “back of the queue”. More generally, the credit information 44, 46, 48 may therefore be reliability information.

Further information 48 of the user of the communications device 1 may in some arrangements of embodiments of the present technique relate to driving aspects, both on a commercial and a personal level—for example, suitability or rating as a taxi driver, or whether the user is a good candidate to be granted car insurance, or how much this car insurance premium might be. Such information might include details of incidents. or travelling history, or times and locations collected by tracking devices on or in the car, or directly through an app on the communications device 1. Such information might be useful for certain insurers or private-hire taxi companies, and may include mileage, speed, times of travel (such as amount of late-night driving) or anything which may increase risk. Such information may also include details of the triggering of automate features in a car, like emergency breaking or collision avoidance.

Yet further information 48 of the user of the communications device 1 may in some arrangements of embodiments of the present technique relate also to work-related information of the user. This might be information defining the user's dedication to their work, such as certificates, achievements, job history, promotions, salaries, reprimands and workplace issues, and may involve assimilating data from career or work-based social media sites such as LinkedIn.

In some embodiments of the present technique, the information 70 provided by the service provider 2 may include indications as to why a particular service has been rejected or accepted, and/or the conditions for accepting a user's request for such a service. The conditions may include such as a relative scoring of the user in respect of their health information, activity information or financial information. In turn, the third party information 70 of the service provider 2 may provide to the user may include information relating to a viability assessment such as a credit rating for the business, which is providing the service to the user, a recent scoring by other users for the service, or a number of other users who have used that service. The third party information 70 may therefore be utilised in the smart app 20 to assure the user that the service provider 2 is credible and able to provide the service which the user is requesting, and ensures that the provision of the service is both bilateral and transparent to both sides.

This third party information 70 may be provided automatically as a matter of course by the service provider 2 on request of the user for the service, but alternatively, the request transmitted by the user for the service (represented in FIG. 1 by dashed line 10) may itself comprise a request for the service provider to transmit an indication of at least a portion of an identity of the service provider and an indication of at least a portion of a credit of the service provider to the communications device 1. Here, the communications device 1 is configured to receive, from the service provider, (for example in a second secure data container 70 such as a Digital Interaction Profile (DIP) of the service provider 2) one or both of an indication 70 of at least a portion of the identity of the service provider 2 and an indication of at least a portion of the credit of the service provider 2. The credit information of the service provider 2 may be impacted positively or negatively in a similar or the same manner as that of the user of the communications device 1 (i.e. rescheduling or poor quality of services could result in a negative credit event being added to the history of the service provider 2). The penalty or benefit of such negative or positive credit history of the service provider 2 is likely to be chiefly reputational, impacting potential future service requests from the user of the communications device 1 or indeed other users, but could take other forms, such as the de-prioritisation or re-prioritisation for budget allocations for non-commercial organisations or some form of brand benefit/penalty if the service provider 2 is a commercial organisation.

Such third party credit information 70 may be particularly beneficial to a user of a communications device 1 when trying to determine whether to request the service from the service provider 2 in some sectors. For example, where the service provider 2 is a travel supplier, or airline or the like, where companies can fairly regularly go bust and leave customers having completed financial obligations but in debt of the service they paid for, or strikes can cause delay or cancellation of services, a user of the communications device 1 may be particularly interested in the commitment or credit of the third party service provider 2.

As described above, the third party service provider 2 may reject the user's request for the service. This may be for any one of a number of reasons. For example, the reason may be that, in some manner the credit 44 or other information 46, 48 of the user is not sufficient; i.e. a value of one or more metrics or fields of that information may be below a predetermined threshold associated with one or both of the service and the service provider 2. Alternatively, or in addition, the reason may be that the service provider 2 is unable to access at least one attribute of the credit 44 of the user, where this attribute is required for a determination (performed at the service provider 2) of whether or not the service should be provided to the user. This inability of the service provider 2 to access the attribute of the user's credit information 44 may be as simple a technical issue requiring retransmission of the request (and hence credit information 44), but may also be because the information 44 provided by the user is insufficient in some way. This may be that the credit information 44 does not include such required information and needs populating through a build-up of credit history or activity by the user, but may be due to the characterisable nature of the credit information 44; i.e. the user has set a level of visibility to at least a part of the credit information 44 which does not allow the service provider 2 to obtain all the information it needs, or the data container 40 comprises a summarisation of the credit information 44 which does not include all of the information the service provider 2 needs regarding one or more attributes of the credit information 44. It should be appreciated by those skilled in the art that., while reference is made in this paragraph to the user's credit information 44, such teachings could be equally applied to any of the identity information 42, or health 46 or other 48 information, where it is this other information 42, 46, 48 which is in some manner insufficient for the service provider 2 to determine that the user should be provided the service.

Furthermore, determine, the service provider 2 may determine, based on the identity 42 of the user, that it is unable to access at least one attribute of the identity 42 and/or that the service provider apparatus is not willing to provide the service to the communications device 1 (e.g. because the user's identity 42 is insufficient in some manner or is deemed to be fraudulent by the service provider 2).

Typically, a user's credit history may not be accessed by the user themselves without running a credit check or some other means of determination of the credit history, which may negatively impact the credit history itself. In accordance with at least some embodiments of the present technique, the user is able to access and see their own credit information 44 or history. This may be stored locally on the communications device 1 and built up over time by recording every interaction and transaction, or the communications device 1 may alternatively (or additionally) be configured to receive (automatically with a set period or after each transaction or on request) an indication of transactions made by the user, and to form the credit of the user by accumulating, over a predetermined period (i.e. before the request for the service is transmitted in response to user selection of the service), the indications of the transactions made by the user. The indication of the transactions made by the user may be stored locally in the memory 120 of the communications device 1, or may be received from the cloud storage 50 or from some other remote storage. Subsequent to forming the credit information 44 or history, an indication of this credit information 44 or history may be stored in the memory 120 of the communications device for easy future access and retrieval by the user, and may be updated periodically, after each (or a set number of) transaction, or on operation by the user. It should be appreciated that this locally stored and accessible credit information 44 or history may not be the same as the credit information 44 within the data container 40 accessed by the service provider 1 on request from the user for the service; particularly if the information 44, 44, 46, 48 within the data container 40 has been summarised or altered in terms of visibility by the user in some manner

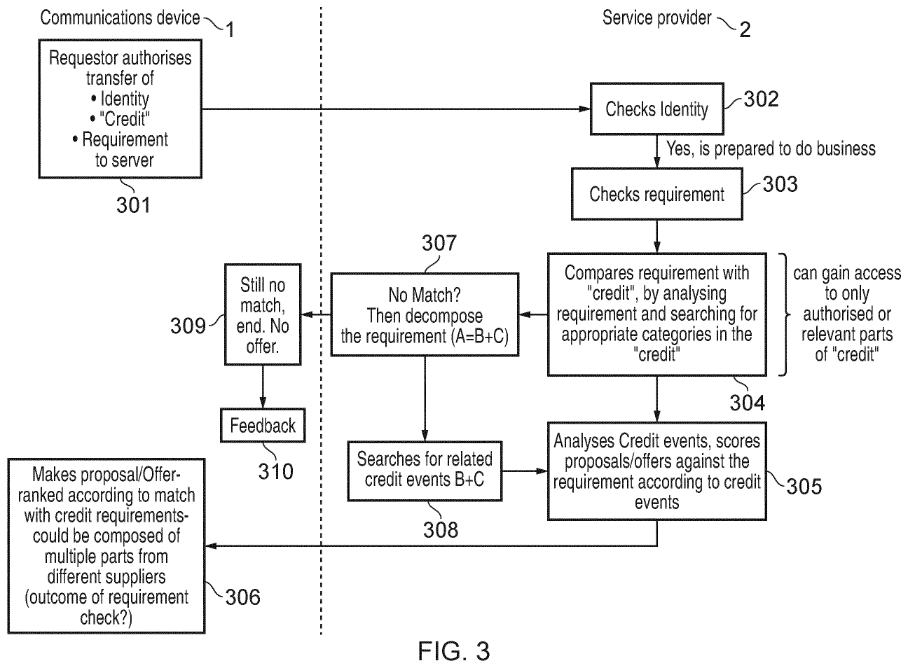

FIG. 3 illustrates an example message flow diagram between a communications device 1 and a service provider 2 in accordance with at least some embodiments of the present technique. Firstly, upon making a request for a service, the communications device 1 authorises the transfer (i.e. in secure data container 40 or by providing authorisation to access data container 40) of identity and credit, and sends this to the service provider 2 along with the requirements of the communications device for the service 301. Here, and in accordance with at least some embodiments of the present technique, the credit in the data container 40 may be aggregated and fully transferred to (or authorised for access by) the service provider 2 as a vector (including health, financial and other aspects) or these aspects/individual credit portions may be separated by type. Upon receipt of this request, the service provider 2 checks the identity 302 of the user of the communications device 1, and determines that it is on this basis prepared to do business with the communications device 1. The service provider 2 then checks 303 both the requirements of the communications device in requesting the service and the requirements needed to be met for the service to be provided to the communications device, and then compares these 304 with the user's credit. This may be done by analysing the requirements and searching for appropriate relevant categories in the credit. As described above, the user may authorise, through characterisation of the data container 40, the service provider 2 only to be able to access certain portions of visible credit (or identity) information, or may only provide a certain amount of summarised information. Thus, the service provider 2 can only gain access to authorised or relevant parts of the user's credit information.

If there is a match—i.e. the service provider 2 determines that the portion(s) of the user's credit information that it is able to access comprises all necessary information to access the communications device's 1 requirement and to test against the service provider's 2 requirements—it analyses 305 credit events, and scores the user's proposals and its offers against the requirements according to the credit events. Following this, the service provider transmits a proposal or an offer 306 to the communications device 1, with services ranked according to the quality of match with the requirement of the communications device initially transmitted to the service provider 1. In at least some embodiments of the present technique, the service provider 2 may determine that it is unable to provide all of the required service, and so communicates with other service providers in order for some parts of the service to be provided by other service providers, or for another service provider to provide all of the service (or part of it along with another service provider) without any portions of the service being provided by the service provider 2. The information that the service provider 2 uses to communicate with the other service providers may not need to include any information from the data container 40 if the service provider 2 itself provides the necessary assurances through its own credit information, thus ensuring privacy of the user of the communications device 1. However, some or all of the user's identity and/or credit information in the data container 40 may need to be shared with these other service providers. Whether or not this is done, or to what extent this is done, is characterisable by the communications device 1 upon transmitting the request for the service to the service provider 2.

If the service provider 2 determines that there is no match between either the services that the communications device 1 requires and those that it is able to provide or between the requirements needed to be met by the communications device 1 for that service to be provided and the credit information of the user of the communications device 1 in the data container 40, the service provider 2 may still be able to provide some level of service to the communications device 1. Here 307, the requirements may be decomposed, to produce a list of one or more services that the service provider 2 is able to provide to the communications device 1 or that the communications device 1 does have authorisation to be provided with given the credit information in the data container 40 that is accessible by the service provider 2. The service provider 2 may then search 308 for related credit events, and again analyse these and scores 305 the user's proposals and its offers against the requirements according to the credit events. Following this, the service provider transmits a proposal or an offer 306 to the communications device 1.

It may be that, even after decomposition of the requirements of the communications device 1 for the service or the requirements of the service provider 2 that the communications device 1 needs to meet to be provided with the service, the service provider 2 determines that it is unable to provide the service to the communications device 1, and so communicates this 309 to the communications device 1 along with feedback 310. The feedback 310 indicates one or more reasons why the service provider 2 could not provide the service to the communications device 1. As described above, at least with respect to FIG. 2, the reasons may include that the identity or credit information of the user in the data container 40 does not satisfy one or more requirements of the service provider 2 to be provided with the service, or one or more pieces of information needed to determine whether such requirements are met are missing from the data container 40. Alternatively, the service provider 2 may determine that it is unable to provide the service to the communications device 1 (regardless of the user's identity or credit information) itself and also determines that it is not aware of any other service providers that are able to provide the service. In some examples however, if the user of the communications device 1 characterises the access to the data container 40 such that its contents are only accessible by the service provider 2, and the service provider 2 is aware of one or more other service providers that could potentially provide the service but would need further information (i.e. an indication of the user's identity and/or credit), then the feedback 310 may provide an indication of this.

In accordance with embodiments of the present technique, identity verification could be performed in various different ways. For example, identities of the user of the communications device 1 or the service provider 2 could be assessed by an authority or notary, or certification rights owned by the user of the communications device 1 or the service provider 2 could be made visible to selected third parties. Alternatively, authenticity could be written in a Distributed Ledger (i.e. blockchain), or a secure physical element (i.e. a secure element of a device in possession of the user of the communications device 1 or the service provider 2 such as a SIM card or a card comprising a chip or some kind) could be used to provide identity of the user of the communications device 1 or the service provider 2 in conjunction with a secure protocol. The authenticity may be written into a virtual SIM card, which may be emulated in software and held either on the communications device 1 or on a secure cloud network, for example. Furthermore, biometric identity management techniques could be used. It should be appreciated by those skilled in the art that the above list is by no means exhaustive, and any number of the above or other methods can be combined.

In at least some arrangements of embodiments of the present technique, the match between a user's identity and/or credit and the requirements needed to be met for access to the requested service may be determined by an independent DIP matchmaker, which is recognised by both the communications device 1 and the service provider 2. The DIP matchmaker may be provided with access to proofs of identity and/or credit and is mandated by one party to issue a certificate and share this with a designated third party. The DIP matchmaker may also act just as a processor or authoriser, in the case that it is requested by one or both of parties A and B to verify that DIP(A) matches the expectations of B and/or that DIP(B) matches the expectations of A. The DIP matchmaker is also able to further refine any matches by quantifying it with scores, of B seen by A, and of A seen by B. Such scores may either be singular values or may comprise vectors of multi-criteria values. Depending on the agreed “market place” and characterisation of the data container 40 by the user of the communications device 1 (and/or similar characterisation of the data container 70 by the service provider 2), such scores may be deleted along with shared identity or credit information and cannot be retrieved following the match. Alternatively, the scores, credit and identity information may be recorded for later use by the communications device 1 and service provider 2 (or indeed shared with other service providers with authorisation from the user) for layer transactions, or for legal challenges or forensics, etc.

Furthermore, in at least some embodiments of the present technique, a Digital Interaction Notary (DIN) may also be recognised by both interacting parties. The DIN records the agreed result of the interaction between the parties, which typically comprises a contract with specified aspects such as the agreed price and the agreed level of service. The role of the DIN is functionally different to that of the DIP matchmaker; the DIP matchmaker triggers the possibility of an interaction, whilst the DIN notary merely follows the interaction and records its agreed result.

Whilst confirmation of identity is a relatively certain science—i.e. the user of the communications device 1 or the service provider 2 is either who they purport to be, or they are not—credit is not quite so straightforward. In at least some arrangements of embodiments of the present technique, the service provider 2 may determine that the credit of the user (which evolves over time in a cumulative manner) or at least one or more relevant parts of the credit of the user is within an expected or required range set for the relevant service.

Broadly, the field of economics is based around supply and demand, and looks at mechanisms to trigger interaction between supply and demand, hopefully leading to matches in interactions from time to time. Economics typically uses utility (or equivalently pre-orders of preference) to model the target of each economic agent in a market. The DIP (i.e. secure data container DIP={id, credit}) approach as described herein and in accordance with embodiments of the present technique enables such an economic system. It focuses on a necessary enabling stage for successful interacting where identities are checked and credits are assessed—on both sides of the interaction and with transparency and privacy being fully controllable by each side—and then matches are proposed and viable interactions are able to take place.

Though embodiments of the present technique have been described largely by way of the example apparatus and systems shown in FIGS. 1, 2 and 3, it would be clear to those skilled in the art that they could be equally applied to other systems to those described herein. For example, different units or circuitries may be included than those which are shown and described, or the steps of described methods may be performed in various orders or delegated in a different way between the units involved.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “some embodiments”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The following numbered paragraphs provide further example aspects and features of the present technique:

Paragraph 1. A communications device for requesting a service for requesting a service from a service provider, comprising:
a processor; and
a memory comprising instructions which when executed, cause the processor:
to transmit a request for the service to the service provider, wherein the request comprises an indication that the service provider is authorised to access a data container, the data container comprising an indication of at least a portion of an identity of a user of the communications device and an indication of at least a portion of a credit of the user;
to receive a response from the service provider, the response indicating whether or not the user of the communications device is authorised to obtain the service based on the indication of the identity of the user and the indication of the credit of the user;
wherein one or both of the at least the portion of the identity of the user and the at least the portion of the credit of the user are characterisable by the user when generating the request for the service.

Paragraph 2. A communications device according to Paragraph 1, wherein the instructions cause the processor
to receive a feedback message from the service provider, the feedback message indicating one or more reasons for the response message indicating whether or not the user of the communications device is authorised to obtain the service.

Paragraph 3 A communications device according to Paragraph 2, wherein the one or more reasons indicated by the feedback message comprise a value of at least one attribute of the credit of the user being below a threshold value.

Paragraph 4. A communications device according to Paragraph 2 or Paragraph 3, wherein the one or more reasons indicated by the feedback message comprise an indication that the service provider is unable to access at least one attribute of the credit of the user, wherein the at least one attribute is required for a determination at the service provider of whether or not the user of the communications device is authorised to obtain the service.

Paragraph 5. A communications device according to any of Paragraphs 2 to 4, wherein the one or more reasons indicated by the feedback message comprise an indication that the service provider apparatus is unable to access at least one attribute of the identity of the user and/or that the service provider apparatus is not willing to provide the service to the communications device.

Paragraph 6. A communications device according to any of Paragraphs 1 to 5, wherein the one or both of the at least the portion of the identity of the user and the at least the portion of the credit of the user are a summarisation of the respective one or both of the identity of the user and the credit of the user comprising only information relevant to the requested service.

Paragraph 7. A communications device according to any of Paragraphs 1 to 6, wherein the identity of the user and the credit of the user each have a plurality of levels of visibility, and wherein the one or both of the at least the portion of the identity of the user and the at least the portion of the credit of the user are associated with to one or more of the levels of visibility of the respective one or both of the identity of the user and the credit of the user for which the service provider is authorised by the user.

Paragraph 8. A communications device according to any of Paragraphs 1 to 7, wherein the instructions cause the processor
to receive an indication of transactions made by the user, and
to form the credit of the user by accumulating, over a predetermined period before the request for the service is transmitted in response to user selection of the service, the indications of the transactions made by the user.

Paragraph 9. A communications device according to Paragraph 8, wherein subsequent to forming the credit of the user, an indication of the credit of the user is stored in the memory of the communications device, the indication of the credit of the user being visible to the user.

Paragraph 10. A communications device according to Paragraph 8 or Paragraph 9, wherein the credit of the user is formed and stored remotely to the communications device, and wherein subsequent to forming the credit of the user, the instructions cause the processor
to receive authentication information for use by the communications device to access the credit of the user from the remote storage.

Paragraph 11. A communications device according to any of Paragraphs 1 to 10, wherein the request for the service comprises a request for the service provider to transmit an indication of at least a portion of an identity of the service provider and an indication of at least a portion of a credit of the service provider to the communications device, and wherein the instructions cause the processor
to receive, from the service provider, one or both of an indication of at least a portion of the identity of the service provider and an indication of at least a portion of the credit of the service provider.

Paragraph 12. A communications device according to any of Paragraphs 1 to 11, wherein the data container is stored in the memory of the communications device.

Paragraph 13. A communications device according to any of Paragraph 1 to 12, wherein the data container is stored remotely from the communications device, and the request for the service comprises authentication information for use by the service provider to access the data container from the remote storage.

Paragraph 14. A method of operating a communications device for requesting a service for requesting a service from a service provider, the method comprising:
transmitting a request for the service to the service provider, wherein the request comprises an indication that the service provider is authorised to access a data container, the data container comprising an indication of at least a portion of an identity of a user of the communications device and an indication of at least a portion of a credit of the user;
receiving a response from the service provider, the response indicating whether or not the user of the communications device is authorised to obtain the service based on the indication of the identity of the user and the indication of the credit of the user;
wherein one or both of the at least the portion of the identity of the user and the at least the portion of the credit of the user are characterisable by the user when generating the request for the service.

Paragraph 15. Circuitry for a communications device for requesting a service for requesting a service from a service provider, comprising:
a processor; and
a memory comprising instructions which when executed, cause the processor:
to transmit a request for the service to the service provider, wherein the request comprises an indication that the service provider is authorised to access a data container, the data container comprising an indication of at least a portion of an identity of a user of the communications device and an indication of at least a portion of a credit of the user;
to receive a response from the service provider, the response indicating whether or not the user of the communications device is authorised to obtain the service based on the indication of the identity of the user and the indication of the credit of the user;
wherein one or both of the at least the portion of the identity of the user and the at least the portion of the credit of the user are characterisable by the user when generating the request for the service.

Paragraph 16. A service provider apparatus for providing a service to a communications device, the service provider apparatus being configured:
to receive a request for the service from the communications device, wherein the request comprises an indication that the service provider is authorised to access a data container, the data container comprising an indication of at least a portion of an identity of a user of the communications device and an indication of at least a portion of a credit of the user;
to determine, based on the request for the service, whether or not the communications device is authorised to obtain the service based on the indication of the identity of the user and the indication of the credit of the user;
to transmit a response to the communications device, the response indicating whether or not the user of the communications device is authorised to obtain the service based on the indication of the identity of the user and the indication of the credit of the user;
wherein one or both of the at least the portion of the identity of the user and the at least the portion of the credit of the user are characterisable by the user when generating the request for the service.

Paragraph 17. A service provider apparatus according to Paragraph 16, configured:
to determine whether the communications device is authorised to obtain the service by comparing one or both of the indication of the identity of the user and the indication of the credit of the user to one or more service requirements.

Paragraph 18. A service provider apparatus according to Paragraph 16 or Paragraph 17, configured:
to transmit a feedback message to the communications device, the feedback message indicating one or more reasons for the response message indicating whether or not the user of the communications device is authorised to obtain the service.

Paragraph 19 A service provider apparatus according to Paragraph 18, configured
to determine, based on the credit of the user, that a value at least one attribute of the credit of the user is below a threshold value,
wherein the one or more reasons indicated by the feedback message comprise the value of the at least one attribute of the credit of the user being below the threshold value.

Paragraph 20. A service provider apparatus according to Paragraph 18 or Paragraph 19, configured
to determine, based on the credit of the user, that the service provider apparatus is unable to access at least one attribute of the credit of the user,
wherein the one or more reasons indicated by the feedback message comprise an indication that the service provider is unable to access the at least one attribute of the credit of the user, and
wherein the at least one attribute is required for a determination at the service provider of whether or not the user of the communications device is authorised to obtain the service.

Paragraph 21. A service provider apparatus according to any of Paragraphs 18 to 20, configured
to determine, based on the identity of the user, that the service provider apparatus is unable to access at least one attribute of the identity of the user and/or that the service provider apparatus is not willing to provide the service to the communications device,
wherein the one or more reasons indicated by the feedback message comprise an indication that the service provider apparatus is unable to access the at least one attribute of the identity of the user and/or that the service provider apparatus is not willing to provide the service to the communications device.

Paragraph 22. A service provider apparatus according to any of Paragraphs 16 to 21, wherein the one or both of the at least the portion of the identity of the user and the at least the portion of the credit of the user are a summarisation of the respective one or both of the identity of the user and the credit of the user comprising only information relevant to the requested service.

Paragraph 23. A service provider apparatus according to any of Paragraph 16 to 22, wherein the identity of the user and the credit of the user each have a plurality of levels of visibility, and wherein the one or both of the at least the portion of the identity of the user and the at least the portion of the credit of the user are associated with to one or more of the levels of visibility of the respective one or both of the identity of the user and the credit of the user for which the service provider is authorised by the user.

Paragraph 24. A service provider apparatus according to any of Paragraphs 16 to 23, wherein the request for the service comprises a request for the service provider to transmit an indication of at least a portion of an identity of the service provider and an indication of at least a portion of a credit of the service provider to the communications device, and wherein the instructions cause the processor
to transmit, to the communications device, one or both of an indication of at least a portion of the identity of the service provider and an indication of at least a portion of the credit of the service provider.

Paragraph 25. A service provider apparatus according to any of Paragraphs 16 to 24, wherein the data container is stored in the memory of the communications device and is received by the service provider apparatus as part of the request for the service.

Paragraph 26. A service provider apparatus according to any of Paragraphs 16 to 25, wherein the data container is stored remotely from the communications device, and the request for the service comprises authentication information for use by the service provider to access the data container from the remote storage.

Paragraph 27. A service provider apparatus according to any of Paragraphs 16 to 26, configured:
to determine that the service provider apparatus is unable to provide at least part of the service to the communications device;
to determine that one or more other service providers are able to provide the at least part of the service to the communications device; and
to transmit a request to the one or more other service providers to provide the at least part of the service to the communications device.

Paragraph 28. A service provider apparatus according to Paragraph 27, wherein the request for the one or more other service providers to provide the at least part of the service to the communications device comprises an indication that the one or more other service providers are authorised to access the data container, the data container being stored remotely from each of the service provider apparatus and the communications device.

Paragraph 29. A service provider apparatus according to Paragraph 28, wherein the request for the one or more other service providers to provide the at least part of the service to the communications device comprises an indication of the data container.

Paragraph 30. A service provider apparatus according to any of Paragraphs 16 to 29, configured:
to determine that the service provider apparatus is unable to provide at least part of the service to the communications device;
to determine that one or more other service providers are able to provide the at least part of the service to the communications device;
to determine that the one or more other service providers are not authorised by the communications device to access the data container; and
to transmit, as part of the feedback message, an indication that, on the condition that the one or more other service providers are authorised to access the data container, the one or more other service providers are able to provide the at least part of the service to the communications device.

Paragraph 31. A method of operating a service provider apparatus for providing a service to a communications device, the method comprising:
receiving a request for the service from the communications device, wherein the request comprises an indication that the service provider is authorised to access a data container, the data container comprising an indication of at least a portion of an identity of a user of the communications device and an indication of at least a portion of a credit of the user;
determining, based on the request for the service, whether or not the communications device is authorised to obtain the service based on the indication of the identity of the user and the indication of the credit of the user;
transmitting a response to the communications device, the response indicating whether or not the user of the communications device is authorised to obtain the service based on the indication of the identity of the user and the indication of the credit of the user;
wherein one or both of the at least the portion of the identity of the user and the at least the portion of the credit of the user are characterisable by the user when generating the request for the service.

Paragraph 32. Circuitry for a service provider apparatus for providing a service to a communications device, the service provider apparatus being configured:
to receive a request for the service from the communications device, wherein the request comprises an indication that the service provider is authorised to access a data container, the data container comprising an indication of at least a portion of an identity of a user of the communications device and an indication of at least a portion of a credit of the user;
to determine, based on the request for the service, whether or not the communications device is authorised to obtain the service based on the indication of the identity of the user and the indication of the credit of the user;
to transmit a response to the communications device, the response indicating whether or not the user of the communications device is authorised to obtain the service based on the indication of the identity of the user and the indication of the credit of the user;
wherein one or both of the at least the portion of the identity of the user and the at least the portion of the credit of the user are characterisable by the user when generating the request for the service.

Paragraph 33. A computer program for causing a computer when executing the computer program to perform the method according to Paragraph 14 or Paragraph 31.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

1. A communications device for requesting a service for requesting a service from a service provider, comprising:
a processor; and
a memory comprising instructions which when executed, cause the processor:
to transmit a request for the service to the service provider, wherein the request comprises an indication that the service provider is authorized to access a data container, the data container comprising an indication of at least a portion of an identity of a user of the communications device and an indication of at least a portion of a credit of the user;
to receive a response from the service provider, the response indicating whether or not the user of the communications device is authorized to obtain the service based on the indication of the identity of the user and the indication of the credit of the user;
wherein one or both of the at least the portion of the identity of the user and the at least the portion of the credit of the user are characterizable by the user when generating the request for the service.

2. The communications device according to claim 1 , wherein the instructions cause the processor to receive a feedback message from the service provider, the feedback message indicating one or more reasons for the response message indicating whether or not the user of the communications device is authorized to obtain the service.

3. The communications device according to claim 2, wherein the one or more reasons indicated by the feedback message comprise a value of at least one attribute of the credit of the user being below a threshold value.

4. The communications device according to claim 2, wherein the one or more reasons indicated by the feedback message comprise an indication that the service provider is unable to access at least one attribute of the credit of the user, wherein the at least one attribute is required for a determination at the service provider of whether or not the user of the communications device is authorized to obtain the service.

5. The communications device according to claim 2, wherein the one or more reasons indicated by the feedback message comprise an indication that the service provider apparatus is unable to access at least one attribute of the identity of the user and/or that the service provider apparatus is not willing to provide the service to the communications device.

6. The communications device according to claim 1, wherein the one or both of the at least the portion of the identity of the user and the at least the portion of the credit of the user are a summarization of the respective one or both of the identity of the user and the credit of the user comprising only information relevant to the requested service.

7. The communications device according to claim 1, wherein the identity of the user and the credit of the user each have a plurality of levels of visibility, and wherein the one or both of the at least the portion of the identity of the user and the at least the portion of the credit of the user are associated with to one or more of the levels of visibility of the respective one or both of the identity of the user and the credit of the user for which the service provider is authorized by the user.

8. The communications device according to claim 1, wherein the instructions cause the processor
to receive an indication of transactions made by the user, and
to form the credit of the user by accumulating, over a predetermined period before the request for the service is transmitted in response to user selection of the service, the indications of the transactions made by the user.

9. The communications device according to claim 8, wherein subsequent to forming the credit of the user, an indication of the credit of the user is stored in the memory of the communications device, the indication of the credit of the user being visible to the user.

10. The communications device according to claim 8, wherein the credit of the user is formed and stored remotely to the communications device, and wherein subsequent to forming the credit of the user, the instructions cause the processor to receive authentication information for use by the communications device to access the credit of the user from the remote storage.

11. The communications device according to claim 1, wherein the request for the service comprises a request for the service provider to transmit an indication of at least a portion of an identity of the service provider and an indication of at least a portion of a credit of the service provider to the communications device, and wherein the instructions cause the processor to receive, from the service provider, one or both of an indication of at least a portion of the identity of the service provider and an indication of at least a portion of the credit of the service provider.

12. The communications device according to claim 1, wherein the data container is stored in the memory of the communications device.

13. The communications device according to claim 1, wherein the data container is stored remotely from the communications device, and the request for the service comprises authentication information for use by the service provider to access the data container from the remote storage.

14. A method of operating a communications device for requesting a service for requesting a service from a service provider, the method comprising:
transmitting a request for the service to the service provider, wherein the request comprises an indication that the service provider is authorized to access a data container, the data container comprising an indication of at least a portion of an identity of a user of the communications device and an indication of at least a portion of a credit of the user;
receiving a response from the service provider, the response indicating whether or not the user of the communications device is authorized to obtain the service based on the indication of the identity of the user and the indication of the credit of the user;
wherein one or both of the at least the portion of the identity of the user and the at least the portion of the credit of the user are characterizable by the user, via circuitry, when generating the request for the service.

15-30. (canceled)

31. A method of operating a service provider apparatus for providing a service to a communications device, the method comprising:
receiving a request for the service from the communications device, wherein the request comprises an indication that the service provider is authorized to access a data container, the data container comprising an indication of at least a portion of an identity of a user of the communications device and an indication of at least a portion of a credit of the user;
determining, based on the request for the service, whether or not the communications device is authorized to obtain the service based on the indication of the identity of the user and the indication of the credit of the user;
transmitting a response to the communications device, the response indicating whether or not the user of the communications device is authorized to obtain the service based on the indication of the identity of the user and the indication of the credit of the user;
wherein one or both of the at least the portion of the identity of the user and the at least the portion of the credit of the user are characterizable by the user when generating the request for the service.

32. (canceled)

33. A non-transitory computer readable storage medium comprising executable code components that, when executed, cause a computer to perform the method according to claim 14.

34. A non-transitory computer readable storage medium comprising executable code components that, when executed, cause a computer to perform the method according to claim 31.

35. The method according to claim 31, further comprising:
transmitting a feedback message to the communications device, the feedback message indicating one or more reasons for the response message indicating whether or not the user of the communications device is authorized to obtain the service.

36. The method according to claim 35, further comprising
determining, based on the credit of the user, that the service provider apparatus is unable to access at least one attribute of the credit of the user,
wherein the one or more reasons indicated by the feedback message comprise an indication that the service provider is unable to access the at least one attribute of the credit of the user, and
wherein the at least one attribute is required for a determination at the service provider of whether or not the user of the communications device is authorized to obtain the service.

37. The method according to claim 31, further comprising:
determining that the service provider apparatus is unable to provide at least part of the service to the communications device;
determining that one or more other service providers are able to provide the at least part of the service to the communications device; and
transmitting a request to the one or more other service providers to provide the at least part of the service to the communications device.
